(19) United States
(12) Patent Application Publication
(10) Pub. No.: US 2012/0033655 A1
(43) Pub. Date: Feb. 9, 2012

(54) DIGITAL CAMERA DEVICE AND GEOGRAPHY TAG OBTAINING METHOD

(75) Inventor: CHENG-WEN TANG, Tu-Cheng (TW)

(73) Assignee: HON HAI PRECISION INDUSTRY CO., LTD., Tu-Cheng (TW)

(21) Appl. No.: 12/892,813

(22) Filed: Sep. 28, 2010

(30) Foreign Application Priority Data
Aug. 3, 2010 (CN) 201010244004.6

(51) Int. Cl. H04W 84/02; H04N 5/225

(52) U.S. Cl. 370/338; 348/207.1; 348/E05.024

(57) ABSTRACT

A digital camera device is located within a wireless local area network (WLAN) which includes a plurality of wireless stations and access points (APs). The digital camera device detects no AP and then detects one wireless station. The digital camera device transmits a disconnection management frame to the detected wireless station by way of pretending to be one of the APs communicating to the detected to the wireless station to notify the detected wireless station to disconnect from the one of the APs. The digital camera device receives a reconnection management frame transmitted by the wireless station to the AP, retrieves a service set identification (SSID) of the AP from the reconnection management frame, and obtains a geography tag according to the retrieved SSID.

### BACKGROUND

1. Technical Field

Embodiments of the present disclosure relate to digital camera devices, and more particularly to a geography tag obtaining method of a digital camera device.

2. Description of Related Art

Newer digital camera devices, such as digital cameras, digital videos, or cell phones, may provide a function that allows addition of a geography tag for each picture or video that is taken. A geography tag shows where the pictures or videos were taken such that the pictures or videos can be shared on the Internet according to the geography tag. Generally, addition of the geography tag is implemented by a wireless network accessing module of the digital camera device, such as by a WIFI module. For example, the digital camera device can communicate with an access point in a wireless local area network where the digital camera device is in by the WIFI module, and obtains the geography tag from the access point.

However, in some conditions, the digital camera device can not detect the access point because of long distance between the digital camera device and the access point, and subsequently the digital camera device can not obtain the geography tag from the access point. Currently, in this condition, the digital camera device abandons to add the geography tag at where the digital camera device can not obtain the geography tag from the access point.

### BRIEF DESCRIPTION OF THE DRAWINGS

The details of the disclosure, both as to its structure and operation, can best be understood by referring to the accompanying drawings, in which like reference numbers and designations refer to like elements.

FIG. 1 is a schematic diagram of environment of one embodiment of a digital camera device of the present disclosure;

FIG. 2 is a schematic diagram of functional modules of one embodiment of a digital camera device of the present disclosure;

FIG. 3 is a schematic diagram of a disassociation or deauthentication frame transmitted by the digital camera device of FIG. 1;

FIG. 4 is a schematic diagram of a probe request transmitted by a wireless station of FIG. 1; and

FIG. 5 is a flowchart of a geography tag obtaining method of one embodiment of the present disclosure.

### DETAILED DESCRIPTION

All of the processes described may be embodied in, and fully automated via, software code modules executed by one or more general purpose computers or processors. The code modules may be stored in any type of computer-readable medium or other storage device. Some or all of the methods may alternatively be embodied in specialized computer hardware or communication apparatus.

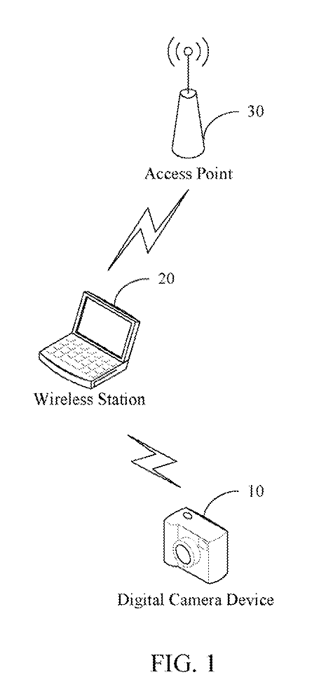

FIG. 1 is a schematic diagram of environment of a digital camera device 10 of one embodiment of the present disclosure. The digital camera device 10 is located within a wireless local area network (WLAN). The WLAN includes a plurality of wireless stations and access points. It is noted that FIG. 1 only shows the wireless station 20 and the access point (AP) 30 for simplicity, and the following description takes the wireless station 20 and the AP 30 for example. The digital camera device 10, the wireless station 20, and the AP 30 all comply with the IEEE 802.11 standard.

In one embodiment, the digital camera device 10 can obtain a service set identification (SSID) of the AP 30 even when the digital camera device 10 can not detect the AP 30. In one embodiment, the digital camera device 10 may be a digital camera, a digital video (DV), a cell phone. The wireless station 20 may be a computer or a cell phone which connects to the WLAN by the AP 30.

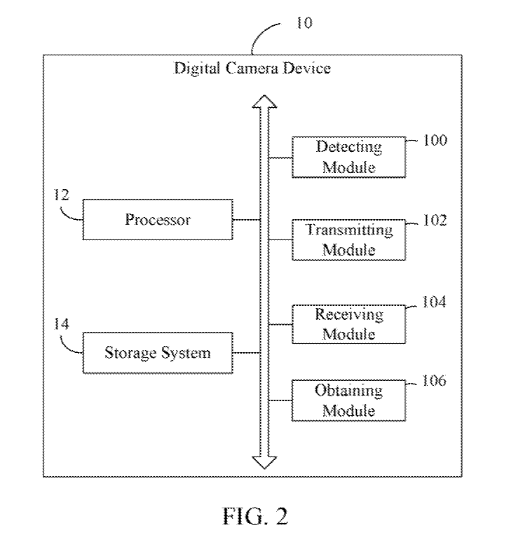

FIG. 2 is a schematic diagram of functional modules of one embodiment of a digital camera device 10 of the present disclosure. In one embodiment, the digital camera device 10 includes a processor 12, a storage system 14, a detecting module 100, a transmitting module 102, a receiving module 104, and an obtaining module 106. The modules 100-106 may comprise computerized code in the form of one or more programs that are stored in the storage system 14. The computerized code includes instructions that are executed by the processor 12 to provide functions for modules 100-106.

The detecting module 100 attempts to detect at least one AP in the WLAN and if no AP can be detected, the detecting module 100 attempts to detect at least one wireless station. For example, the detecting module 100 can detect the wireless station 20, and the wireless station 20 can access to the Internet via the AP 30.

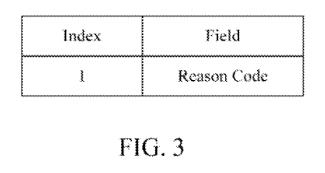

The transmitting module 102 transmits a disconnection management frame to the wireless station 20 by way of pretending to be the AP 30 to notify the wireless station 20 that the AP 30 disconnects to the wireless station 20. In one embodiment, the disconnection management frame may be a deauthentication or a disassociation (DE/DIS) frame. FIG. 3 is a schematic diagram of the DE/DIS frame. The DE/DIS frame mainly includes a reason code field which is configured to notify the wireless station 20 disconnection reasons.

As such, the wireless station 20 receives the DE/DIS frame and considers itself disconnects from the AP 30. Then, the wireless station 20 transmits a reconnection management frame to connect to the AP 30.

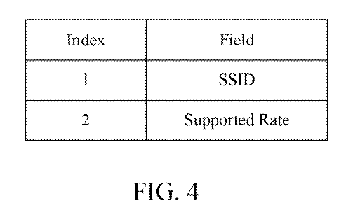

In one embodiment, the reconnection management frame may be a probe request. FIG. 4 is a schematic diagram of the probe request. The probe request mainly includes a SSID field and a supported rate field. Generally, the SSID field stores the SSID of the AP 30. In other embodiments, if the SSID field of the probe request does not stores the SSID of the AP 30, then the reconnection management frame may also be an association frame which includes the SSID of the AP 30.

Then, the receiving module 104 also receives the reconnection management frame transmitted by the wireless station 20 to the AP 30. The obtaining module 106 retrieves the SSID of the AP 30 from the SSID field of the reconnection management frame, and then obtains a geography tag according to the retrieved SSID.

It is noted the DE/DIS frame, the probe request, the association frame are defined in the IEEE 802.11 standard, thus the detail description of them are omitted.

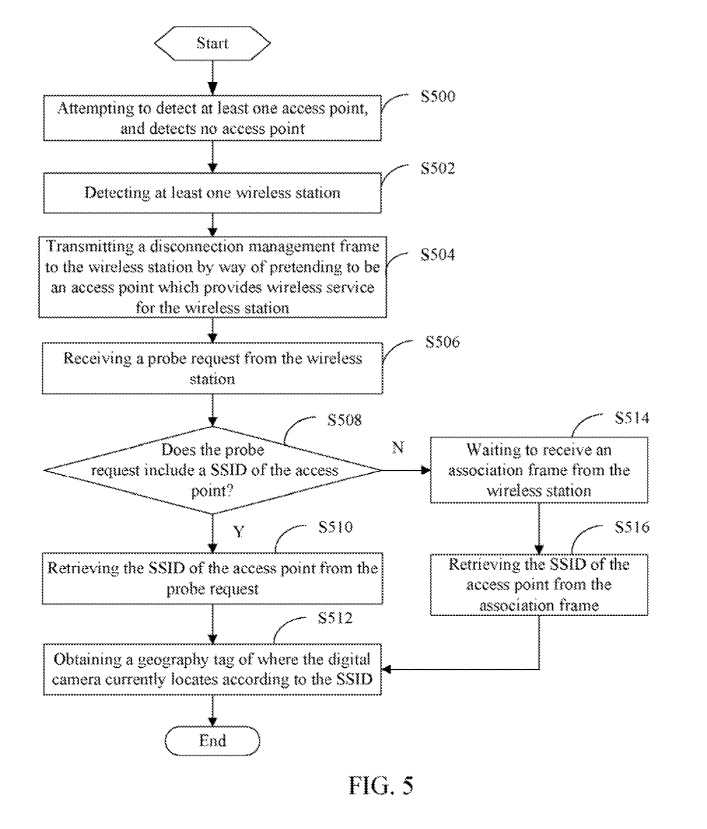

FIG. 5 is a flowchart of a geography tag obtaining method of one embodiment of the present disclosure. The flowchart is executed by the modules of FIG. 2. Depending on the embodiment, additional blocks may be added, others deleted, and the ordering of blocks may be changed while remaining well within the scope of the disclosure.

In block S500, the detecting module 100 attempts to detect at least one AP, and if no AP can be detected, then in block S502, the detecting module 100 attempts to detect at least one wireless station. For example, the detecting module 100 can detect the wireless station 20, and the wireless station 20 can access to the Internet via the AP 30.

In block S504, the transmitting module 102 transmits a disconnection management frame to the wireless station 20 by way of pretending to be the AP 30 to notify the wireless station 20 that the AP 30 disconnects to the wireless station 20. In one embodiment, the disconnection management frame may be a disassociation frame or a deauthentication frame.

Then the wireless station 20 transmits a reconnection management frame to connect to the AP 30. The wireless station 20 stores a SSID of the AP 30 in the reconnection management frame. In one embodiment, the reconnection management frame may be a probe request or an association frame.

In block S506, the receiving module 104 receives the probe request transmitted by the wireless station 20 to the AP 30. In block S508, the receiving module 104 determines if the probe request includes the SSID of the AP 30.

If the probe request includes the SSID of the AP 30, then in block S510, the obtaining module 106 retrieves the SSID of the AP 30 from the probe request, and in block S512, obtains a geography tag according to the retrieved SSID of the AP 30.

If the probe request does not include the SSID of the AP 30, then in block S514, the receiving module 104 waits to receive the association frame transmitted by the wireless station 20 to the AP 30. In block S516, the obtaining module 106 retrieves the SSID of the AP 30 from the association frame, and in block S512, obtains a geography tag according to the retrieved SSID of the AP 30.

The digital camera device 10 and the geography tag obtaining method of the present disclosure transmit the DE/DIS frame to the wireless station 20 by way of pretending to be the AP 30 and retrieve the SSID of the AP 30 according to the probe request or the association frame from the wireless station 20 when the digital camera device 10 can not detect the AP 30. Therefore, even when the digital camera device 10 can not detect the AP 30, the digital camera device 10 can also add a geography tag when the digital camera device 10 takes a picture or a video, which highly improves customer satisfaction.

While various embodiments of the present disclosure have been described above, it should be understood that they have been presented by way of example only and not by way of limitation. Thus the breadth and scope of the present disclosure should not be limited by the above-described embodiments, but should be defined only in accordance with the following claims and their equivalents.

What is claimed is:

1. A digital camera device located within a wireless local area network (WLAN), the WLAN comprising a plurality of wireless stations and access points, the digital camera device comprising a processor, a storage system, and one or more programs stored in the storage system and operable to be executed by the processor, the one or more programs comprising:
a detecting module to detect at least one of the access points, and detect at least one of the wireless stations upon the condition that none of the access points are detected;
a transmitting module to transmit a disconnection management frame to the detected wireless station by way of pretending to be one of the access points communicating to the detected wireless station to notify the detected wireless station to disconnect from the one of the access points, wherein the wireless station transmits a reconnection management frame to reconnect to the one of the access points upon receiving the disconnection management frame;
a receiving module to receive the reconnection management frame; and
an obtaining module to retrieve a service set identification of the one of the access points from the reconnection management frame, and to obtain a geography tag according to the retrieved service set identification.

2. The digital camera device as claimed in claim 1, wherein the disconnection management frame is a deauthentication frame.

3. The digital camera device as claimed in claim 1, wherein the disconnection management frame is a disassociation frame.

4. The digital camera device as claimed in claim 1, wherein the reconnection management frame is a probe request.

5. The digital camera device as claimed in claim 1, wherein the reconnection management frame is an association frame.

6. The digital camera device as claimed in claim 1, wherein the digital camera device, the wireless stations, and the access points all comply with the IEEE 802.11 standard.

7. A geography tag obtaining method of a digital camera device located within a wireless local area network (WLAN) comprising a plurality of wireless stations and access points, the method comprising:
detecting at least one of the access points;
detecting at least one of the wireless stations if none of the access points is detected;
transmitting a disconnecting management frame to the detected wireless station by way of pretending to be one of the access points communicating to the detected wireless station to notify the detected wireless station to disconnect from the one of the access points, wherein the detected wireless stations transmits a reconnection management frame to reconnect to the one of the access points;
receiving the reconnection management frame from the detected wireless stations;
retrieving a service set identification of the one of the access points from the reconnection management frame; and
obtaining a geography tag according to the retrieved service set identification.

8. The method as claimed in claim 7, wherein the disconnection management frame is a deauthentication frame or a disassociation frame.

9. The method as claimed in claim 7, wherein the reconnection management frame is a probe request or an association frame.

10. The method as claimed in claim 7, wherein the digital camera device, the wireless stations, and the access points all comply with the IEEE 802.11 standard.
